(19) United States
(12) Patent Application Publication
(10) Pub. No.: US 2015/0029404 A1
(43) Pub. Date: Jan. 29, 2015

(54) SMART KEYBOARD

(71) Applicant: YOMORE TECHNOLOGY CO., LTD., Kaohsiung City (TW)

(72) Inventors: Jao-Ching Lin, Kaohsiung City (TW); Wen-Ting Lee, Kaohsiung City (TW); Chun-Kai Ni, Kaohsiung City (TW)

(21) Appl. No.: 14/337,171

(22) Filed: Jul. 21, 2014

(30) Foreign Application Priority Data
Jul. 25, 2013 (TW) 102214021

(51) Int. Cl. H04N 5/44; G06F 3/041; G06F 3/02

(52) U.S. Cl. CPC H04N 5/4403; G06F 3/02; G06F 3/0412; H04N 2005/4407; H04N 2005/4408; H04N 2005/4412; H04N 2005/4416; H04N 2005/4428; H04N 2005/443; H04N 2005/4426
USPC 348/734

(57) ABSTRACT

A smart keyboard for establishing bidirectional communication between a television and a portable device includes a wireless module, a socket, a touch panel, and a processor. The wireless module is used for establishing a wireless connection with the television. The processor is used for controlling operation of the television through the wireless connection or controlling the television to display contents displayed on the portable device through the wireless connection when the portable device is fixed on the socket according to a first command generated by the touch panel.

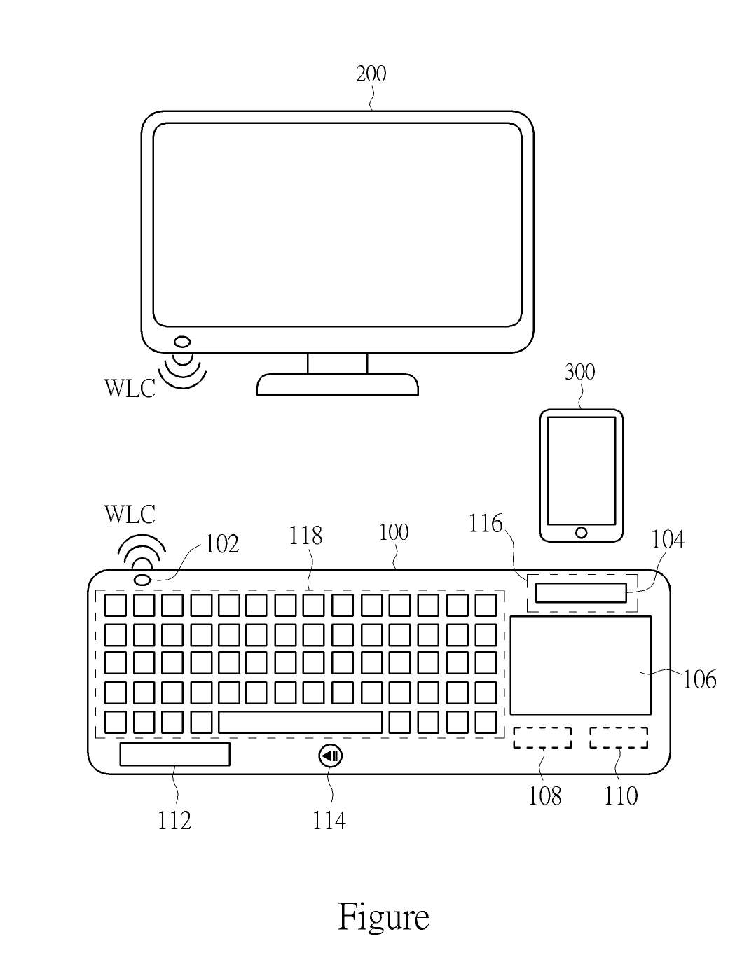

### BACKGROUND OF THE INVENTION

1. Field of the Invention

The present invention relates to a smart keyboard, and particularly to a smart keyboard that can establish bidirectional communication between a television and a portable device.

2. Description of the Prior Art

In the prior art, although a keyboard provided by the prior art can communicate with a television (that is, the keyboard can control the television through a wired or wireless method), the keyboard provided by the prior art can only unidirectionally control the television to display contents displayed on a mobile phone and not download television programs to the mobile phone, resulting in convenience of the keyboard being significantly limited. Therefore, the keyboard provided by the prior art can not make a user obtain more convenience.

Particularly, when the mobile phone and the television are developed toward intelligence, the keyboard provided by the prior art can not satisfy a requirement of the user, so a smarter and more convenient smart keyboard is very essential for the user.

### SUMMARY OF THE INVENTION

An embodiment provides a smart keyboard for establishing bidirectional communication between a television and a portable device. The smart keyboard includes a wireless module, a socket, a touch panel, and a processor. The wireless module is used for establishing a wireless connection with the television. The processor is used for controlling operation of the television through the wireless connection or controlling the television to display contents displayed on the portable device through the wireless connection when the portable device is fixed on the socket according to a first command generated by the touch panel.

The present invention provides a smart keyboard. The smart keyboard has advantages as follows: first, because the smart keyboard can simultaneously control a portable device and a television, the smart keyboard can act as a platform for exchanging, integrating, storing, or playing contents between the portable device and the television; second, when the portable device is not fixed on the smart keyboard, the smart keyboard can act as a remote control through a wireless connection between the smart keyboard and the television; and third, the smart keyboard can also utilize a touch panel thereof to directly play files stored in a memory thereof. Therefore, compared to the prior art, the smart keyboard provided by the present invention is smarter and more convenient for a user.

These and other objectives of the present invention will no doubt become obvious to those of ordinary skill in the art after reading the following detailed description of the preferred embodiment that is illustrated in the various FIGURE and drawings.

### BRIEF DESCRIPTION OF THE DRAWINGS

The FIGURE is a diagram illustrating a smart keyboard for establishing bidirectional communication between a television and a portable device according to an embodiment.

### DETAILED DESCRIPTION

Please refer to the FIGURE. The FIGURE is a diagram illustrating a smart keyboard 100 for establishing bidirectional communication between a television and a portable device according to an embodiment. The smart keyboard 100 includes a wireless module 102, a socket 104, a touch panel 106, and a processor 108. The wireless module 102 is used for establishing a wireless connection WLC with a television 200, where the wireless module 102 establishes the wireless connection WLC with the television 200 through a wireless LAN (WLAN), a Zigbee (IEEE 802.15.4), a Bluetooth, a Bluetooth low energy (BLE), a Worldwide Interoperability for Microwave Access (WiMAX), a Global System for Mobile Communications (GSM), a General Packet Radio Service (GPRS), a third generation (3G), or an actor network theory+ (Ant+) technology. The processor 108 is used for controlling operation of the television 200 through the wireless connection WLC (meanwhile, the smart keyboard 100 can be regarded as a remote control of the television 200) according to a first command generated by the touch panel 106. That is to say, the television 200 and the touch panel 106 can simultaneously display the same contents. In addition, when a portable device 300 is fixed on the socket 104, the processor 108 can control the television 200 to display contents displayed on the portable device 300 through the wireless connection WLC. That is to say, when the portable device 300 is fixed on the socket 104, the television 200, the touch panel 106, and the portable device 300 can simultaneous display the contents displayed on the portable device 300, where the portable device 300 is a mobile phone, a tablet personal computer, or a personal digital assistant. In addition, when the portable device 300 is fixed on the socket 104, a user can control the portable device 300 and the television 200 through the touch panel 106.

As shown in the FIGURE, the smart keyboard 100 further includes a memory 110, where the memory 110 is a flash memory or a dynamic random access memory (DRAM). But, the present invention is not limited to the memory 110 being a flash memory or a dynamic random access memory. That is, the memory 110 can also be another type memory. Therefore, after the wireless connection WLC between the smart keyboard 100 and the television 200 is established, the memory 110 can be used for storing at least one program played by the television 200. When the portable device 300 is fixed on the socket 104, the user can utilize the touch panel 106 to generate a second command. Then, the processor 108 can store the at least one program played by the television 200 to the portable device 300 through the socket 104 according to the second command generated by the touch panel 106. In addition, when the processor 108 controls the television 200 to display the contents displayed on the portable device 300 through the wireless connection WLC, the processor 108 first stores the contents displayed on the portable device 300 to the memory 110 through the socket 104, then controls the memory 110 to output the contents displayed on the portable device 300 to the television 200 through the wireless connection WLC, and controls the television 200 to display the contents displayed on the portable device 300 through the wireless connection WLC.

As shown in the FIGURE, the smart keyboard 100 further includes a speaker 112 and a microphone 114. But, the present invention is not limited to the smart keyboard 100 only including one speaker and one microphone. Therefore, when the portable device 300 is fixed on the socket 104, the user can utilize the touch panel 106 to generate a third command. Then, the processor 108 can make the smart keyboard 100 connect communication service of the portable device 300 according to the third command generated by the touch panel 106. After the smart keyboard 100 connects the communication service of the portable device 300, the user can utilize the speaker 112, the microphone 114, and the communication service of the portable device 300 to execute a mobile phone function (e.g. a video conference or a conference call). In addition, when the portable device 300 is fixed on the socket 104, the smart keyboard 100 can also act as a mobile router according to the communication service of the portable device 300.

As shown in the FIGURE, the smart keyboard 100 further includes a charging base 116, where the charging base 116 is coupled to the socket 104. When the portable device 300 is fixed on the socket 104, the charging base 116 can execute a charging function on the portable device 300, or the charging base 116 can execute the charging function on the portable device 300 through near field communication (NFC) when a distance between the portable device 300 and the charging base 116 is within a predetermined distance. But, the present invention is not limited to the charging base 116 executing the charging function on the portable device 300 through the near field communication. That is to say, the charging base 116 can execute the charging function on the portable device 300 through other communication standards.

As shown in the FIGURE, the smart keyboard 100 further includes a button portion 118, where the button portion 118 includes a plurality of buttons, and the plurality of buttons of the button portion 118 are physical buttons, touch buttons, or virtual buttons. The user can utilize at least one button of the plurality of buttons of the button portion 118 to generate a fourth command. Then, the processor 108 can control the operation of the television 200 through the wireless connection WLC or control the television 200 to display the contents displayed on the portable device 300 through the wireless connection WLC when the portable device 300 is fixed on the socket 104 according to the fourth command generated by the at least one button of the plurality of buttons. In addition, when the portable device 300 is fixed on the socket 104, the user can also utilize at least one button of the plurality of buttons to generate a fifth command. Then, the processor 108 can store the at least one program played by the television 200 to the portable device 300 through the socket 104 according to the fifth command generated by the at least one button of the plurality of buttons.

To sum up, the smart keyboard provided by the present invention has advantages as follows: first, because the smart keyboard can simultaneously control the portable device and the television, the smart keyboard can act as a platform for exchanging, integrating, storing, or playing contents between the portable device and the television; second, when the portable device is not fixed on the smart keyboard, the smart keyboard can act as a remote control through a wireless connection between the smart keyboard and the television; and third, the smart keyboard can also utilize the touch panel to directly play files stored in the memory. Therefore, compared to the prior art, the smart keyboard provided by the present invention is smarter and more convenient for the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A smart keyboard for establishing bidirectional communication between a television and a portable device, the smart keyboard comprising:
a wireless module for establishing a wireless connection with the television;
a socket;
a touch panel; and
a processor for controlling operation of the television through the wireless connection or controlling the television to display contents displayed on the portable device through the wireless connection when the portable device is fixed on the socket according to a first command generated by the touch panel.

2. The smart keyboard of claim 1, wherein when the processor controls the operation of the television through the wireless connection according to the first command generated by the touch panel, the television and the touch panel simultaneously display a same contents.

3. The smart keyboard of claim 1, wherein when the portable device is fixed on the socket, the television and the touch panel simultaneously display the contents displayed on the portable device.

4. The smart keyboard of claim 1, further comprising:
a memory for storing at least one program played by the television, wherein the processor stores the at least one program to the portable device through the socket according to a second command generated by the touch panel when the portable device is fixed on the socket.

5. The smart keyboard of claim 4, wherein the processor controlling the television to display the contents displayed on the portable device through the wireless connection when the portable device is fixed on the socket is the processor storing the contents displayed on the portable device to the memory through the socket, controlling the memory to output the contents displayed on the portable device to the television through the wireless connection, and controlling the television to display the contents displayed on the portable device through the wireless connection.

6. The smart keyboard of claim 1, further comprising:
a speaker; and
a microphone;
wherein the touch panel is further used for generating a third command to make the smart keyboard connect communication service of the portable device, and the speaker, the microphone, and the communication service of the portable device are used for executing a mobile phone function after the smart keyboard connects the communication service of the portable device.

7. The smart keyboard of claim 6, wherein the mobile phone function is a video conference or a conference call.

8. The smart keyboard of claim 6, wherein the smart keyboard acts as a mobile router according to the communication service of the portable device when the portable device is fixed on the socket.

9. The smart keyboard of claim 1, further comprising:
a charging base coupled to the socket, wherein when a distance between the portable device and the charging base is within a predetermined distance, the charging base executes a charging function on the portable device.

10. The smart keyboard of claim 1, further comprising:
a button portion comprising a plurality of buttons, wherein at least one button of the plurality of buttons is used for generating a fourth command, and the processor controls the operation of the television through the wireless connection or controls the television to display the contents displayed on the portable device through the wireless connection when the portable device is fixed on the socket according to the fourth command.

11. The smart keyboard of claim 10, wherein the plurality of buttons are physical buttons, touch buttons, or virtual buttons.

12. The smart keyboard of claim 10, further comprising:
a memory for storing at least one program played by the television, wherein the processor stores the at least one program to the portable device through the socket according to a fifth command generated by at least one button of the plurality of buttons when the portable device is fixed on the socket.

13. The smart keyboard of claim 1, wherein the wireless module establishes the wireless connection with the television through a wireless LAN (WLAN), a Zigbee (IEEE 802.15.4), a Bluetooth, a Bluetooth low energy (BLE), a Worldwide Interoperability for Microwave Access (WiMAX), a Global System for Mobile Communications (GSM), a General Packet Radio Service (GPRS), a third generation (3G), or an actor network theory+ (Ant+) technology.

14. The smart keyboard of claim 1, wherein the portable device is a mobile phone, a tablet personal computer, or a personal digital assistant.
